(19) United States
(12) Patent Application Publication
(10) Pub. No.: US 2024/0151985 A1
(43) Pub. Date: May 9, 2024

(54) RX SHELL READY TO RX

(71) Applicant: Essilor International, Charenton-Le-Pont (FR)

(72) Inventors: Mathieu MEYNEN, Charenton Le Pont (FR); Sira UHALTE NOGUES, Charenton Le Pont (FR); Chefik HABASSI, Charenton Le Pont (FR); Nicolas MAITRE, Charenton Le Pont (FR); Antoine MONVOISIN, Charenton Le Pont (FR)

(73) Assignee: Essilor International, Charenton-Le-Pont (FR)

(21) Appl. No.: 18/548,598

(22) PCT Filed: Mar. 4, 2022
(86) PCT No.: PCT/EP2022/055547

§ 371 Date: Sep. 1, 2023

(30) Foreign Application Priority Data
Mar. 5, 2021 (EP) 21305265.7

(51) Int. Cl. G02C 1/00; G02C 9/00

(52) U.S. Cl. CPC G02C 1/10; G02C 9/00

(57) ABSTRACT

A method and an optical system adapted for a wearer having an ophthalmic prescription. The optical system includes an optical device having a planar optical function, and an optical lens having an optical function based on the prescription of the wearer. The rear face of the optical device is attached to the front face of the optical lens, the optical device having at least one mechanical reference so as to allow an accurate relative position of the optical device and the optical lens.

### FIELD OF THE DISCLOSURE

The disclosure is in the field of ophthalmic lenses and, more particularly, it relates to an optical system adapted for a wearer having an ophthalmic prescription. The optical systems according to the disclosure are recommended for adding an optical lens to an optical device, for instance adding an optical device comprising electrochromic features to an optical lens having an optical function based on the prescription of the wearer. The attachment of the optical lens to the optical device can be achieved by several different means.

### BACKGROUND OF THE DISCLOSURE

It is known some existing solutions of lens assembly with finish optical lens glued (in all surface or in the edge), and some solutions with clip add-on.

Nevertheless, such lens assemblies have disadvantages, and several problems have to be solved. The first problem concerns the position of the optical lens. To guarantee a good optical lens add-on, the optical lens has to be placed onto (or closed to) the optical device with a good accuracy.

Another issue relates to the integration into a frame. Two criteria are engaged: the aesthetic and the easiness of the mounting. When using gluing for the attachment of the lens to the optical device, the management of the overspread of the glue is a key point.

In the case of gluing, the management of the overspread is done by the definition of a glue pattern. The positioning is managed via centering system which places the optical lens at the right position and via a preflash solution which enables to fix the optical lens in order to avoid some displacement during the polymerization of the glue.

Therefore, there is a need for a simple and accurate means for the attachment of optical lens to optical devices.

Thus, one object of the present disclosure is to provide an optical system wherein the attachment of the two lenses is facilitated through several means.

### SUMMARY OF THE DISCLOSURE

To this end, the disclosure proposes an optical system adapted for a wearer having an ophthalmic prescription, comprising:
an optical device,
an optical lens,
   wherein the combination of the optical device and the optical lens has an optical function based on the prescription of the wearer, and a face of the optical device is attached to a face of the optical lens, the optical device having at least one mechanical reference so as to allow an accurate relative position of the optical device and the optical lens.

Advantageously, thanks to such optical system, the proposed solution is independent of the material of the optical device. Another benefit is that this solution minimizes frictions between the optical lens and the optical device during the attachment, so there is no stress on the optical lens edge that would create delamination.

According to the disclosure, the optical lens relates to any type of optical lens having a dioptric function corresponding to the prescription of the wearer. The optical device relates to any type of lens which does not have a dioptric function. In other words the optical device is a plano optical device. The optical device may have another optical function such as transmission functions and/or polarization functions. The optical device may comprise features such as active optical elements. The optical device may have an anti-reflective coating, an anti-glare coating, an electrochromic function or any active optical function. The optical device can be a shell for electrochromic, or a plano lens for prescription sunglasses, or a lens providing combiner for antireflective eyeglasses. The optical device may be plastic part, injection or casting (for instance, for sun plano lenses). The optical device may be mineral part, with supplementary step of providing mechanical means using for instance additive manufacturing via polymerjetting. Use of mineral part can be relevant for electrochromic application, or antireflective eyeglasses application.

For example, an optical device having an electrochromic function may be added to an optical lens having a dioptric function corresponding to the prescription of the wearer but no electrochromic function to obtain an optical system having a dioptric function corresponding to the prescription of the wearer and an electrochromic function.

Advantageously, this solution can be used to add prescription on all kind of lens including active lenses such as for augmented reality or virtual reality.

Advantageously, it is possible to add new mechanical references to an optical device already having mechanical references to allow further adjustments of the position of the optical lens relative to the optical device. This allows further customizing the optical device to adapt the optical device to a new optical lens or a new wearer instead of designing a new optical device. It further allows extra adjustments of the optical device to the optical lens to achieve higher degree of customization according to the wearer's needs.

Since the optical lens footprint is smaller or of the same size as the optical device, it can be possible to add an optical lens to an optical device already mounted on an eyewear, since access to the mechanical reference may be not prevented by the eyewear rim.

According to further embodiments which can be considered alone or in combination:
the at least one mechanical reference is on the periphery of the optical device; and/or
any part of the at least one mechanical reference is outside the projected surface defined by the contour of the lens on the optical device when a face of the optical device is attached to a face of the optical lens; and/or
the at least one mechanical reference allows customizing the position of the optical lens relative to the optical device according to the wearer's needs,
a rear face of the optical device is attached to the front face of the optical lens; and/or
the curvature of the rear surface of the optical device is greater or equal to the curvature of the front surface of the optical lens; and/or
the curvature of the rear surface of the optical lens is greater or equal to the curvature of the front surface of the optical device; and/or
the front face and/or the rear face of the optical device and/or the optical lens comprise an anti-reflective coating and/or a blue cut coating and/or an antifog coating and/or whatever coating available; and/or
the optical device and the optical lens are attached together by means of at least one clip; and/or
the optical device and the lens are attached together with magnets; and/or
the optical device and the optical lens are attached by an adhesive; and/or
the adhesive is on the interior surface of the optical system delimited by the mechanical reference, the rear surface of the optical device and the front surface of the optical lens or by the mechanical reference, the rear surface of the optical lens and the front surface of the optical device; and/or
the adhesive is on the mechanical references only; and/or
the rear face of the optical device and the front face of the optical lens are in contact or separated by an adhesive; and/or
the rear face of the optical lens and the front face of the optical device are in contact or separated by an adhesive; and/or
the optical system comprises an air gap, at least between a point of the surface of the rear face of the optical device and a point of the surface of the front face of the optical lens; and/or
the optical system comprises an air gap, at least between a point of the surface of the rear face of the optical lens and a point of the surface of the front face of the optical device; and/or
the contact between the mechanical reference and the optical lens provides sealing so that no dust or moisture can penetrate in the volume occupied by the air gap; and/or
the at least one mechanical reference comprise at least a groove; and/or
the at least one mechanical reference comprises at least a step; and/or
the at least one mechanical reference comprises at least a drain; and/or
the at least one mechanical reference comprises a cylindrical hole.

The disclosure further relates to a method for providing an optical system adapted for a wearer, for example according to any of the disclosures, the method comprising:
providing an optical device having at least one mechanical reference,
providing an optical lens,
   wherein the combination of the optical device and the optical lens has an optical function based on the prescription of the wearer,
positioning in the position of reference the optical device and the optical lens relatively to each other with the help of the mechanical reference to allow the attachment of a face of the optical device to a face of the optical lens,
attaching in the above-defined reference position a face of the optical device to a face of the optical lens.

### BRIEF DESCRIPTION OF THE DRAWINGS

Embodiments of the disclosure will now be described, by way of example only, and with reference to the following drawings in which:

FIGS. 1a and 1b are schematic representations of an optical system comprising an optical device and an optical lens, the combination of the optical device and the optical lens having an optical function based on the prescription of the wearer, according to an exemplary embodiment of the disclosure; in FIG. 1a, the eyewear is assembled contrary to FIG. 1b.

FIG. 2 is a schematic representation of the optical device illustrated on FIGS. 1a and 1b.

FIG. 3 is a schematic representation of an optical system according to an embodiment of the disclosure, wherein the optical device and the optical lens are in contact.

FIG. 4 is a schematic representation of an optical system according to an embodiment of the disclosure, wherein the optical device and the optical lens are separated by an adhesive.

FIG. 5 is a schematic representation of an optical system according to an embodiment of the disclosure, wherein the optical device and the optical lens are separated by an air gap.

Elements in the figures are illustrated for simplicity and clarity and have not necessarily been drawn to scale. For example, the dimensions of some of the elements in the figure may be exaggerated relative to other elements to help improve the understanding of the embodiments of the present disclosure.

### DETAILED DESCRIPTION OF PREFERRED EMBODIMENTS

The disclosure relates to an optical system adapted for a wearer having an ophthalmic prescription, comprising an optical device and an optical lens, the combination of the optical device and the optical lens having an optical function based on the said ophthalmic prescription of the wearer.

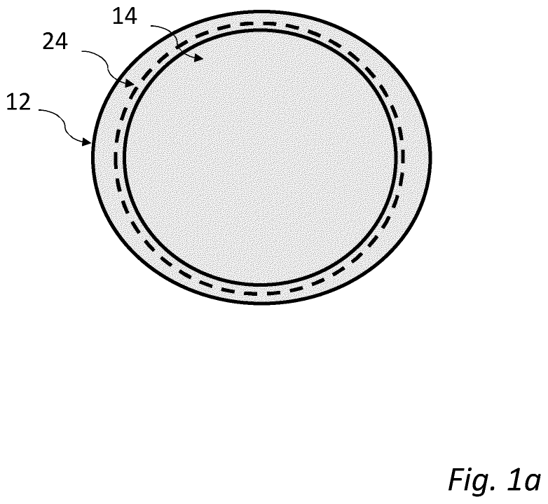

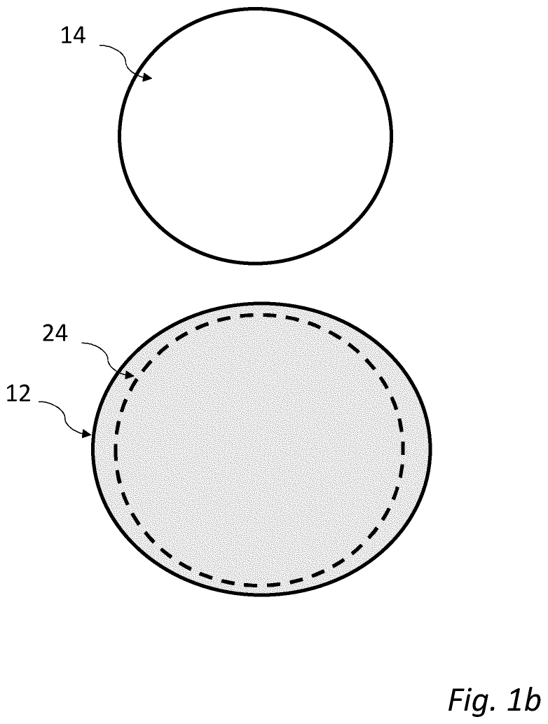

FIGS. 1a and 1b represent an example of optical system comprising an optical device 12 and an optical lens 14. In FIG. 1a, the optical system is assembled contrary to FIG. 1b wherein the optical lens 14 is not yet fastened to the optical device 12. The optical device 12 may have different optical designs and/or different optical powers. The optical device 12 may be a single vision lens, a progressive addition lens, a bifocal lens or a trifocal lens. The optical device 12 may be provided with different tints and/or different functional coatings.

The optical lens 14 may have different optical designs and/or different optical powers. The optical lens 14 may be a single vision lens, a progressive addition lens, a bifocal lens or a trifocal lens.

The combination of the optical device 12 and the optical lens 14 has an optical function based on the prescription of the wearer.

According to a preferred embodiment of the invention, the rear face 18 of the optical device 12 is attached to the front face 20 of the optical lens 14.

Preferably, the front surface 20 of the optical lens 14 is spherical, so that the front geometry of the optical lens 14 is not depending on the contour position. Practically, the front geometry will be independent of the position of the optical center, and not depending on the position of the contour on the optical lens.

The optical system may be configured in order to be mounted on an eyewear frame.

The optical device 12 may be manufactured in order to be adapted to all kind of active lens. The optical device 12 may be configured in order to be attached to an active lens 14 that is already mounted on an eyewear frame.

Advantageously, a user who already wears eyeglasses with an optical function which is not provided with a tint and/or a functional coating can ask to an eye care professional to mount an optical device 12 having a tint and/or a functional coating on his eyeglasses.

The optical device 12 and the optical lens 14 are arranged in order to be attached to each other.

Advantageously, the optical device 12 has at least one mechanical reference 24 so as to allow an accurate relative position of the optical device 12 and the optical lens 14.

In other words, the optical device 12 comprises means for adjusting the position of the optical device 12 and the optical lens 14 during the attachment of the optical device 12 to the optical lens 14.

Preferably, the at least one mechanical reference 24 is on the periphery of the optical device 12.

Advantageously, being positioned on the periphery of the optical device 12, the mechanical references 24 do not disturb vision.

Moreover, the at least one mechanical reference allows customizing the position of the optical lens relative to the optical device according to the wearer's needs.

Advantageously, additional mechanical references can be designed in the optical device to allow further adjustments of the position of the optical lens relative to the optical device. This allows further customizing the optical device to adapt the optical device to a new optical lens or a new wearer instead of designing a new optical device. It further allows extra adjustments of the optical device to the optical lens to achieve higher degree of customization according to the wearer's needs.

Preferably, the mechanicals means 24 have limited size so as to provide maximal field of view.

Preferably, any part of the at least one mechanical reference 24 is outside the projected surface defined by the contour of the optical lens 14 on the optical device 12 when the rear face 18 of the optical device 12 is attached to the front face 20 of the optical lens 14.

According to an embodiment of the disclosure, the front face 16 and/or the rear face 18 of the optical device 12 and/or the front face 20 and/or the rear face 22 of the optical lens 14 comprise an anti-reflective coating.

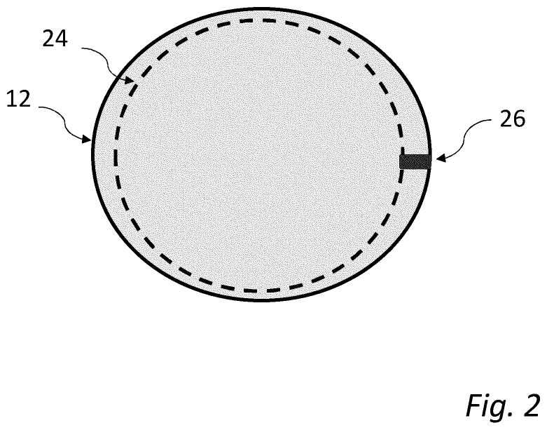

FIG. 2 represents an example of optical device 12. The rear face 18 of the optical device 12 is provided with at least one mechanical reference 24. The mechanical reference 24 can be provided in various shapes as explained herein above. The mechanical reference 24 can be in 2D (for instance a mark at the surface of the rear face 18 of the optical device 12) or in 3D (for instance a hole, a step, a groove).

Mechanical means 24 may include spacers. The spacers ensure that no contact exists between the optical device 12 and the optical lens 14 except on the mechanical reference 24.

Advantageously, when the optical system is assembled, an air gap 30 is created between the rear face 18 of the optical device 12 and the front face 20 of the optical lens 14.

An optical device 12 can be provided with several different types of mechanical reference all at once.

Preferably, several mechanical reference 24 can be associated to define a continuous or non-continuous contour which coincides with the contour of the optical lens 14 or which contains the projected surface defined by the contour of the optical lens 14 on the optical device 12 when the rear face 18 of the optical device 12 is attached to the front face 20 of the optical lens 14.

Preferably, the shape of the mechanical reference 24 is the same as the optical lens contour. Alternatively, the mechanical reference 24 may be provided in more sophisticated shapes to let accessible some areas of the optical system, may be cylindrical holes for receiving glue acting as bonding pads, integrates a drain to evacuate an adhesive surplus during bonding.

Preferably, a mechanical reference thickness can be defined so that, when the optical device 12 is mounted on the eyewear, the mechanical reference 24 is still fully accessible to add optical lens 14 later. If the optical device 12 and the optical lens 14 are added together inside the frame, the eyewear rim does not superpose to the mechanical reference 24. A gap is necessary between the outside contour of the mechanical reference 24 and the inside contour of the rim. The width of the mechanical reference 24 may be defined from one side of the edge of the optical device to the inner contour of the rim.

According to an embodiment, the curvature of the rear surface 18 of the optical device 12 is greater than the curvature of the front surface 20 of the optical lens 14.

According to an embodiment, the curvature of the rear surface 18 of the optical device 12 is equal to the curvature of the front surface 20 of the optical lens 14.

Advantageously, the difference of curvature between the rear surface 18 of the optical device 12 and the curvature of the front surface 20 of the optical lens 14 creates an air gap 30 between the two surfaces. Depending on the method of assembling, the created volume between the two surfaces can be sealed.

According to an embodiment of the disclosure, the mechanical reference 24 comprises a groove.

According to an embodiment of the disclosure, the mechanical reference 24 comprises a step.

Preferably, the groove is deep enough in order to let the space for the adhesive 28.

Advantageously, this feature allows to contain the adhesive 28 within the groove and limits its overspread over the surface of the rear face 18 of the optical device 12 and over the surface of the front face 20 of the optical lens 14.

According to an embodiment of the disclosure, the mechanical reference 24 comprises a cylindrical hole.

According to an embodiment of the disclosure, the mechanical reference 24 comprises a drain 26. The drain 26 is configured to evacuate the adhesive surplus out of the optical system.

Advantageously, the drain 26 allows the excess of adhesive to be removed during the attachment of the optical device 12 to the optical lens 14.

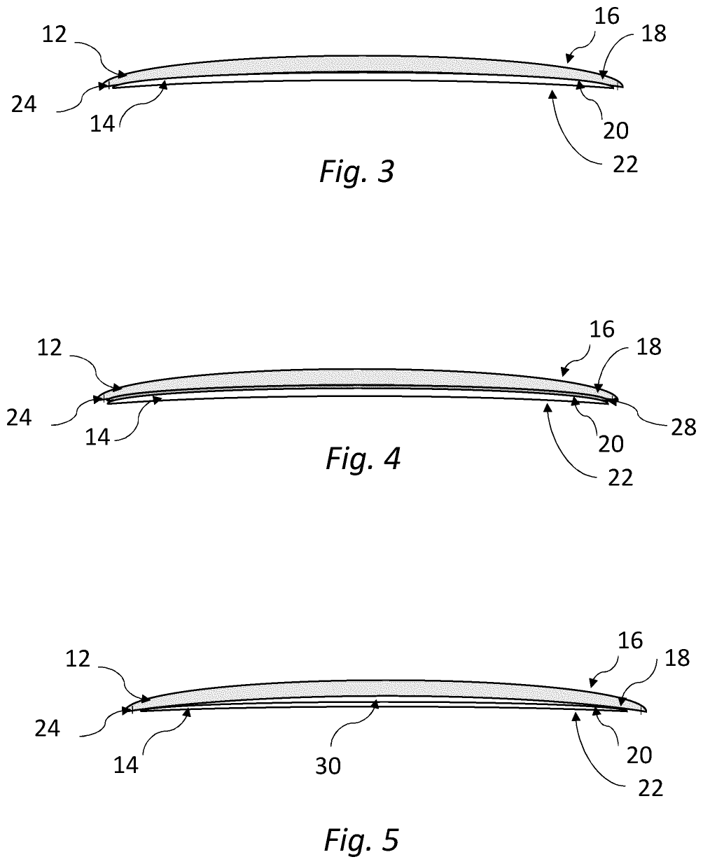

FIG. 3 represents an optical system according to an embodiment of the disclosure, wherein the optical device 12 and the optical lens 14 are in contact.

According to an embodiment of the disclosure, the optical device 12 can be fastened to the optical lens by various means which should not be limited to: ring, glue or integrate solution which permits to fix it on the frame such as brackets.

According to an embodiment of the disclosure, the optical device 12 and the optical lens 14 are attached together by means of at least one clip.

According to an embodiment of the disclosure, the optical device 12 and the optical lens 14 are attached together with at least one magnet.

According to an embodiment of the disclosure, the optical device 12 and the optical lens 14 are attached together by an adhesive 28. For instance, the adhesive can be a pressure sensitive adhesive, a cyanoacrylate adhesive, an epoxy adhesive and is not limited to any kind of adhesive.

Preferably, in the case of a mechanical reference 24 having the shape of a groove or a cylindrical hole or any kind of shape designing an empty volume, the mechanical reference is deep enough in order to contain the adhesive 28 and to limit the overspread.

In the case of the use of an attachment of the optical device 12 to the optical lens 14 using an adhesive, two types of attachment are possible: full gluing or edge bonding.

In the case of full gluing, the adhesive 28 may be put in the central part. The groove around the gluing area help to manage the overspread.

In the case of edge-bonding, the external ring defined by the mechanical reference 24 may be a step or a groove, depending on the function expected by this area.

If the glue is dispensed in the ring area, we are in an air gap case. The ring area is a groove or a step for the liquid glue and a step for the pressure sensitive adhesive.

Depending on method of attachment of the optical device 12 and the optical lens 14, and/or depending on the curvature of the rear face 18 of the optical device 12 and of the curvature of the front face 20 of the optical lens 14, the rear face 18 and the front face 20 can be in contact or separated by an adhesive 28 or a gap 30.

FIG. 4 represents an optical system according to an embodiment of the disclosure, wherein the optical device 12 and the optical lens 14 are separated by an adhesive 28.

FIG. 5 represents an optical system according to an embodiment of the disclosure, wherein the optical device 12 and the optical lens 14 are separated by an air gap 30, at least between a point of the surface of the rear face 18 of the optical device 12 and a point of the surface of the front face 20 of the optical lens 14.

Advantageously, the contact between the mechanical reference 24 and the optical lens 14 provides sealing so that no dust or moisture can penetrate in the volume occupied by the air gap 30, preventing the need to clean the rear face 18 of the optical device 12 and the front face 20 of the optical lens 14 after the attachment of the optical device 12 to the optical lens 14.

Another object of the disclosure relates to a method for providing an optical system adapted for a wearer, for example according to any of the preceding claims. The method comprises at least:
providing S10 an optical device having at least one mechanical reference,
providing S12 an optical lens,
   wherein the combination of the optical device and the optical lens has an optical function based on the prescription of the wearer,
positioning S14 in the position of reference the optical device and the optical lens relatively to each other with the help of the mechanical reference to allow the attachment of a face of the optical device to a face of the optical lens,
attaching S16 in the above-defined reference position a face of the optical device to a face of the optical lens.

The disclosure has been described above with the aid of embodiments without limitation of the general inventive concept.

Many further modifications and variations will be apparent to those skilled in the art upon making reference to the foregoing illustrative embodiments, which are given by way of example only and which are not intended to limit the scope of the disclosure, that being determined solely by the appended claims.

In the claims, the word “comprising” does not exclude other elements or steps, and the indefinite article “a” or “an” does not exclude a plurality. The mere fact that different features are recited in mutually different dependent claims does not indicate that a combination of these features cannot be advantageously used. Any reference signs in the claims should not be construed as limiting the scope of the disclosure.

1. An optical system adapted for a wearer having an ophthalmic prescription, comprising:
an optical device; and
an optical lens,
wherein the combination of the optical device and the optical lens has an optical function based on the prescription of the wearer and a face of the optical device is attached to a face of the optical lens, the optical device having at least one mechanical reference so as to allow an accurate relative position of the optical device and the optical lens.

2. The optical system according to claim 1, wherein the at least one mechanical reference is on the periphery of the optical device.

3. The optical system according to claim 1, wherein any part of the at least one mechanical reference is outside the projected surface defined by the contour of the lens on the optical device when a face of the optical device is attached to a face of the optical lens.

4. The optical system according to claim 1, wherein the curvature of the rear surface of the optical device is different or equal to the curvature of the front surface of the optical lens.

5. The optical system according to claim 1, wherein the front face and/or the rear face of the optical device and/or the optical lens comprise an anti-reflective coating, and/or a blue cut coating and/or an antifog coating and/or whatever coating available.

6. The optical system according to claim 1, wherein the optical device and the lens are attached together with magnets.

7. The optical system according to claim 1, wherein the optical device and the optical lens are attached by an adhesive.

8. The optical system according to claim 7, wherein the adhesive is on the mechanical references only.

9. The optical system according to claim 1, wherein the rear face of the optical device and the front face of the optical lens or the rear face of the optical lens and the front face of the optical device are in contact or separated by an adhesive.

10. The optical system according to claim 1, wherein an air gap is present, at least between a point of the surface of the rear face of the optical device and a point of the surface of the front face of the optical lens or between a point of the surface of the rear face of the optical lens and a point of the surface of the front face of the optical device.

11. The optical system according to claim 10, wherein the contact between the mechanical reference and the optical lens provides sealing so that no dust or moisture can penetrate in the volume occupied by the air gap.

12. The optical system according to claim 1, wherein the at least one mechanical reference comprises at least a groove.

13. The optical system according to claim 1, wherein the at least one mechanical reference comprises at least a step.

14. The optical system according to claim 1, wherein the at least one mechanical reference comprises at least a drain.

15. A method for providing an optical system adapted for a wearer, the method comprising:
providing an optical device having at least one mechanical references;
providing an optical lens, wherein the combination of the optical device and the optical lens has an optical function based on the prescription of the wearers;
positioning in the position of reference the optical device and the optical lens relatively to each other with the help of the mechanical reference to allow the attachment a face of the optical device to a face of the optical lens; and
attaching in the above-defined reference position a face of the optical device to a face of the optical lens.
